(19) United States
(12) Patent Application Publication
(10) Pub. No.: US 2003/0033158 A1
(43) Pub. Date: Feb. 13, 2003

(54) Method and system for determining service resources allocation

(75) Inventors: Thomas L. Hill, Dallas, TX (US); Curtis J. Connell, Plano, TX (US)

Correspondence Address: David G. Wille, Esq., BAKER BOTTS L.L.P., Suite 600, 2001 Ross Avenue, Dallas, TX, 75201-2980, US

(73) Assignee: Electronic Data Systems Corporation

(21) Appl. No.: 09/925,569

(22) Filed: Aug. 9, 2001

(51) Int. Cl. G06F 17/60

(52) U.S. Cl. 705/1

(57) ABSTRACT

According to one embodiment, a method for determining service resources allocation includes associating a generic value stream having a plurality of generic value stream components with a plurality of industry segments, allocating, for at least one of the industry segments, expenditures for a time period to at least one of the plurality of generic value stream components for the industry segment, and determining, for at least one of the industry segments, the amount of expenditures associated with the at least one of the plurality of generic value stream components relative to the total amount of expenditures for the at least one industry segment. The determination is for use in determining the resource allocation.

### TECHNICAL FIELD OF THE INVENTION

The present invention relates generally to the services industry, and more particularly to a method and system for determining service resources allocation.

### BACKGROUND OF THE INVENTION

A company typically strives to be as profitable as possible. Generally, profitability is determined by subtracting expenses from net sales. Therefore, for a company to become more profitable, the company should try to either increase net sales or decrease expenses.

Consulting services assist in a company's profitability by, among other things, decreasing costs. Consulting service companies may offer any number of services to companies that desire better profitability. However, before offering services to other companies, a consulting service company needs to determine what type of services to offer.

### SUMMARY OF THE INVENTION

According to one embodiment of the invention, a method for determining service resources allocation includes associating a generic value stream, having a plurality of generic value stream components, with a plurality of industry segments, allocating, for at least one of the industry segments, expenditures for a time period to at least one of the plurality of generic value stream components for the industry segment, and determining, for at least one of the industry segments, the amount of expenditures associated with the at least one of the plurality of generic value stream components relative to the total amount of expenditures for the at least one industry segment. The determination is for use in determining the resource allocation.

According to another embodiment of the invention, a method for determining service resources allocation includes associating a generic value stream, having a plurality of generic value stream components, with a plurality of industry segments, allocating a change in revenue information between time periods to a first industry segment, the revenue information selected from the group consisting of net sales and gross profits, allocating input North American Industry Classification System codes to a second industry segment, wherein at least one of the input North American Industry Classification System codes is associated with the first industry segment, and determining a revenue information trend associated with the first industry segment based on the allocated change in revenue information for use in determining the resource allocation for the second industry segment.

Embodiments of the invention provide a number of technical advantages. Embodiments of the invention may include all, some, or none of these advantages. In one embodiment, a services company can allocate or de-allocate resources more efficiently and economically by having an aggregation of industry data available in a user-friendly form. A services company can become more profitable itself by understanding changes in one or more industry segments. Public information may be used by a services company to better predict trends in the marketplace.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1 is a block diagram illustrating a system for determining service resources allocation according to one embodiment of the invention;

FIG. 2 is a block diagram of a computer in the system of FIG. 1 for use in determining service resources allocation according to one embodiment of the invention;

FIGS. 3A through 3J illustrate a database for use in determining service resources allocation according to one embodiment of the invention;

FIG. 4 is one embodiment of a data model for use in the computer of FIG. 2; and

FIGS. 5A through 5C are flowcharts illustrating example methods of determining service resources allocation.

### DETAILED DESCRIPTION OF EXAMPLE EMBODIMENTS OF THE INVENTION

Example embodiments of the present invention and their advantages are best understood by referring now to FIGS. 1 through 5C of the drawings, in which like numerals refer to like parts.

FIG. 1 is a block diagram illustrating a system 100 for determining service resources allocation according to one embodiment of the present invention. System 100 includes a services company 102 employing a resource allocator 104 having access to a computer 200. Services company 102 provides services to companies in one or more industries 105 having associated industry segments 106. System 100 also includes public information 108 that may include a myriad of public information, such as North American Industry Classification System (“NAICS”) codes 110, NAICS financial information 112, Securities and Exchange Commission (“SEC”) filings 114, and other miscellaneous information 116. System 100 may also utilize information not publicly available in lieu of, or in addition to, public information 108.

Services company 102 is any suitable services company that provides services to companies within one or any number of industry segments 106 to help those companies increase sales and profits and/or decrease costs. Since services company 102 often has a goal of being a profitable company, services company 102 must be efficient in allocating service resources to specific industry segments 106. Therefore, services company 102 employs resource allocator 104 to help determine allocation of their service resources. Resource allocator 104 is either an individual employee or a group of employees employed by services company 102.

Industry segments 106, which may be identified by one or more NAICS codes, are segments of industries 105. Examples of industries 105 are the utilities industry, the financial and transportation industry, the healthcare industry, the communication, entertainment, and media industry, products and retail industry, and other industries. Examples of industry segments 106 are, for the utilities industry, the water industry, electricity industry, oil and natural gas industry, chemicals industry, and the mining industry. Although not illustrated in FIG. 1, industry segments 106 comprise a plurality of companies. For example, the oil and natural gas industry is comprised of representative companies, such as Shell Oil company, Exxon Mobil company, and Texaco company.

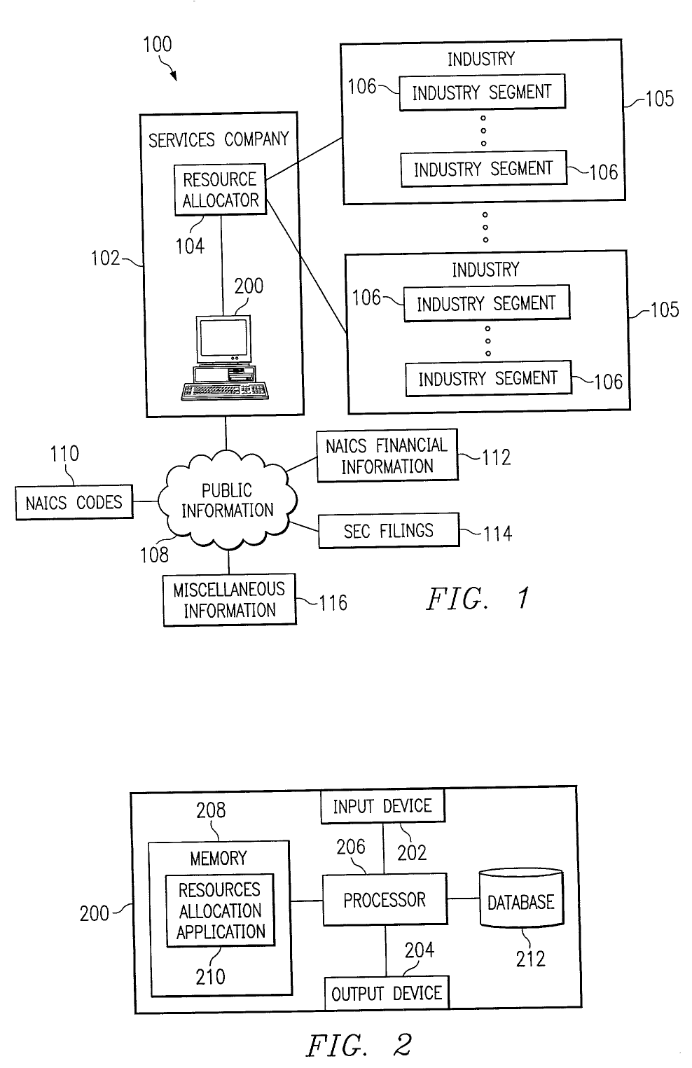

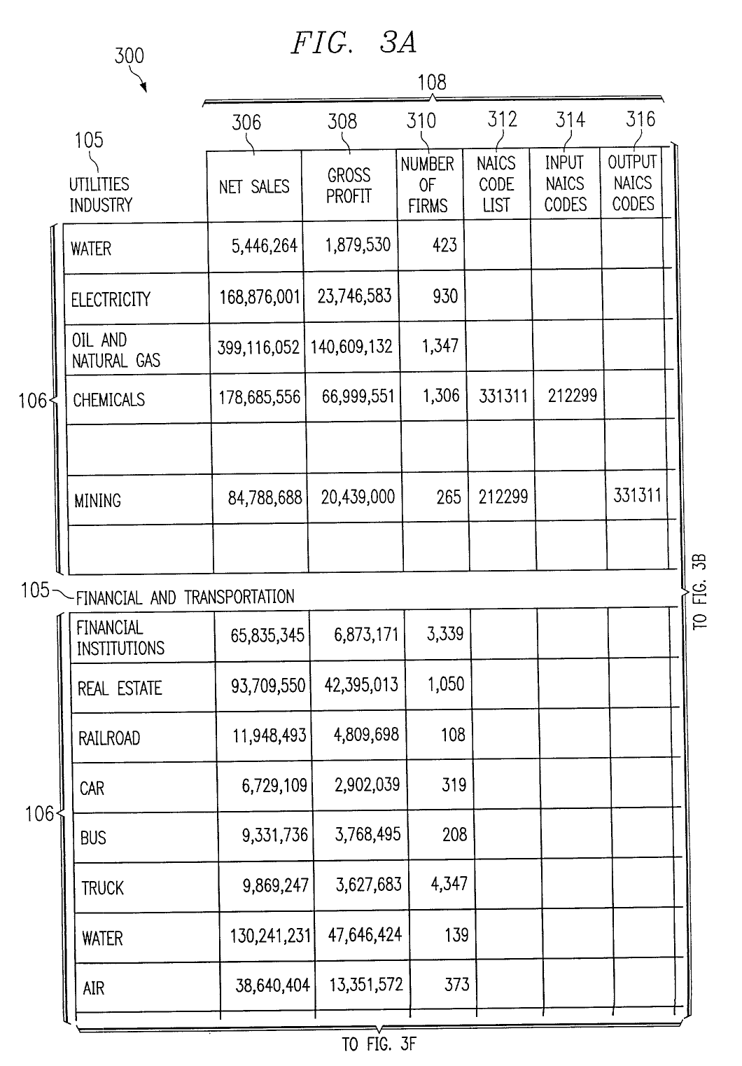

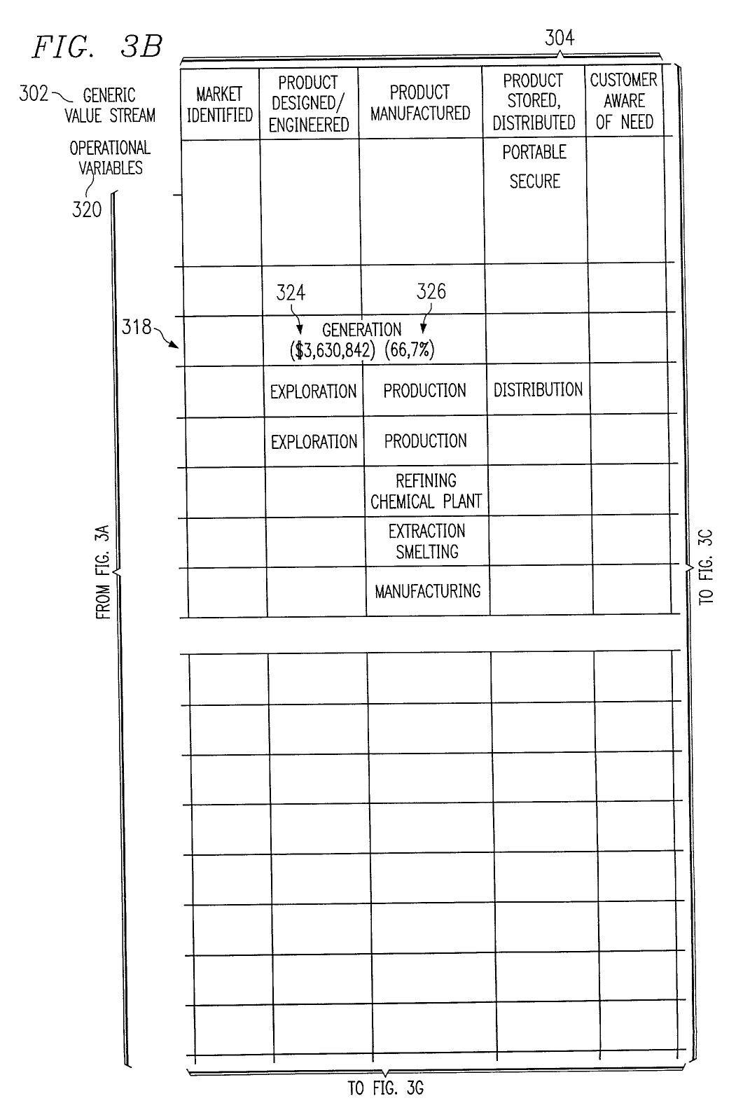

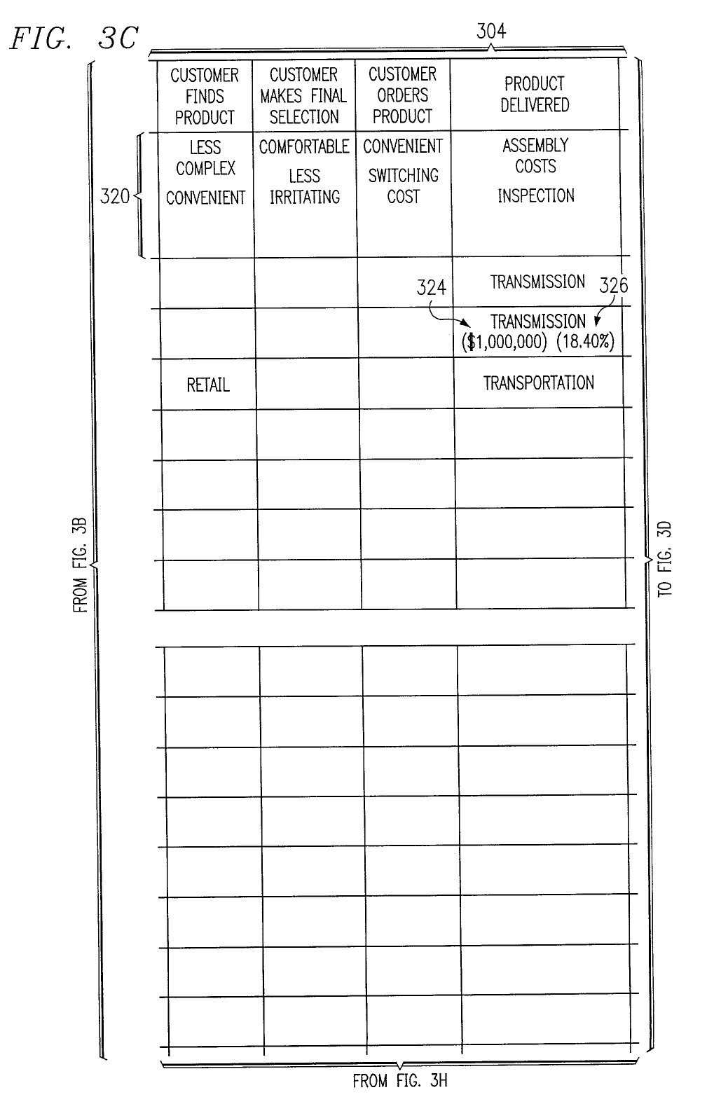

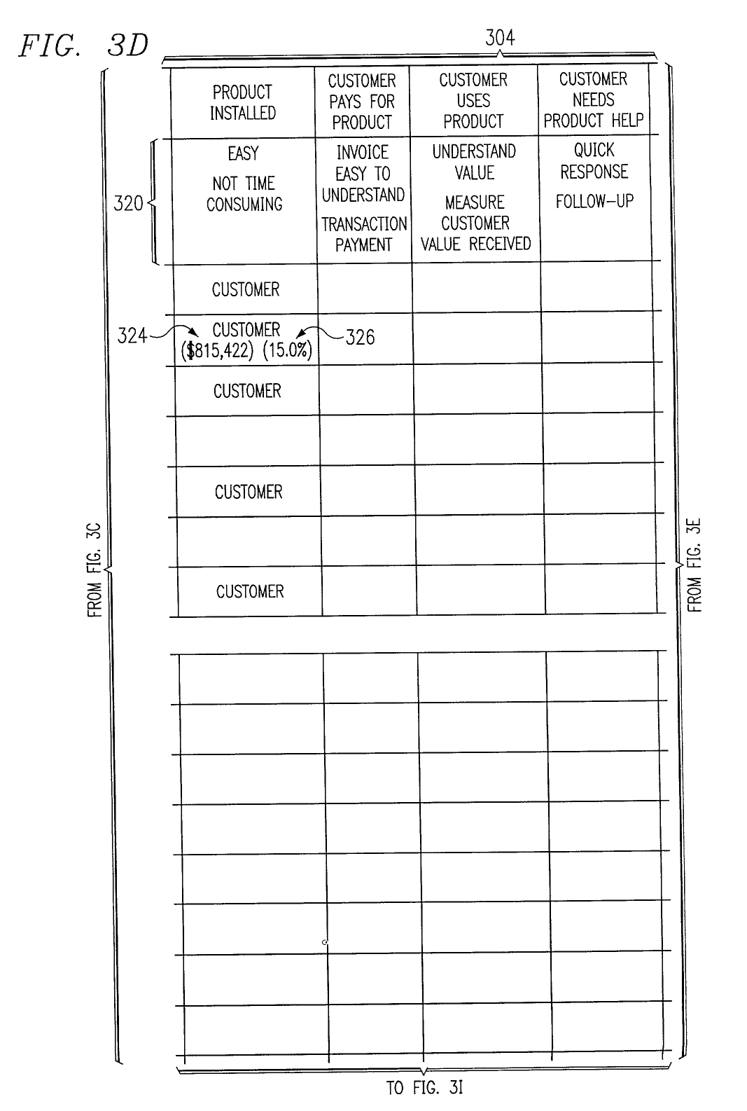

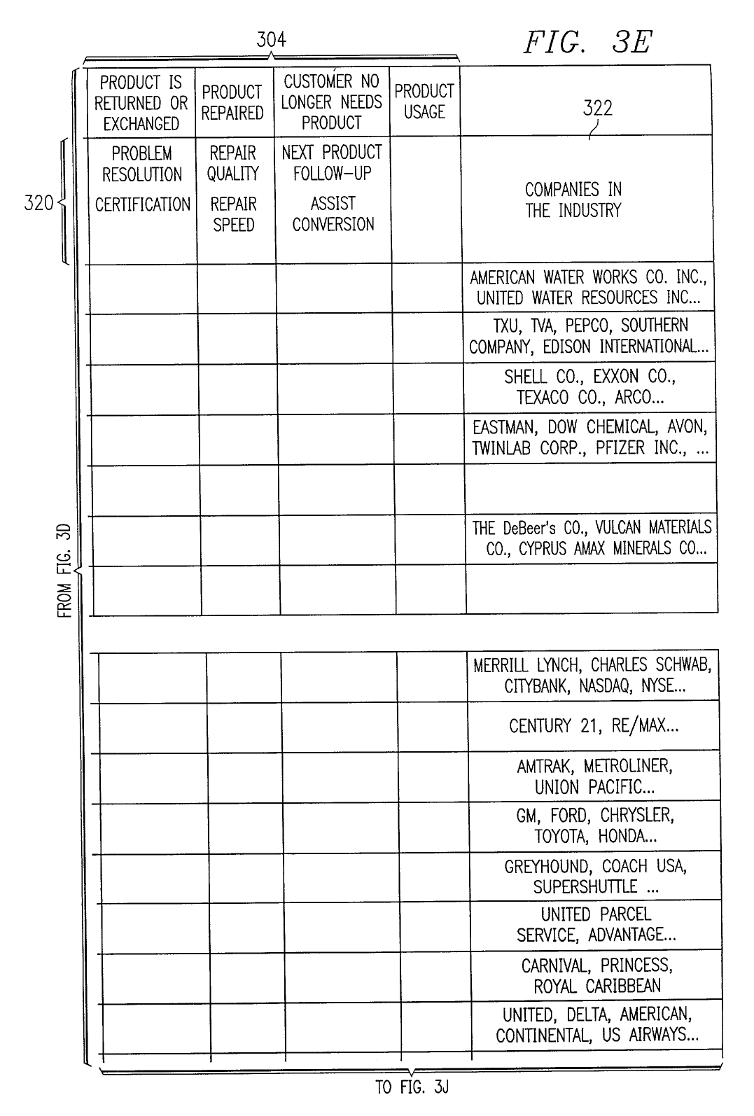

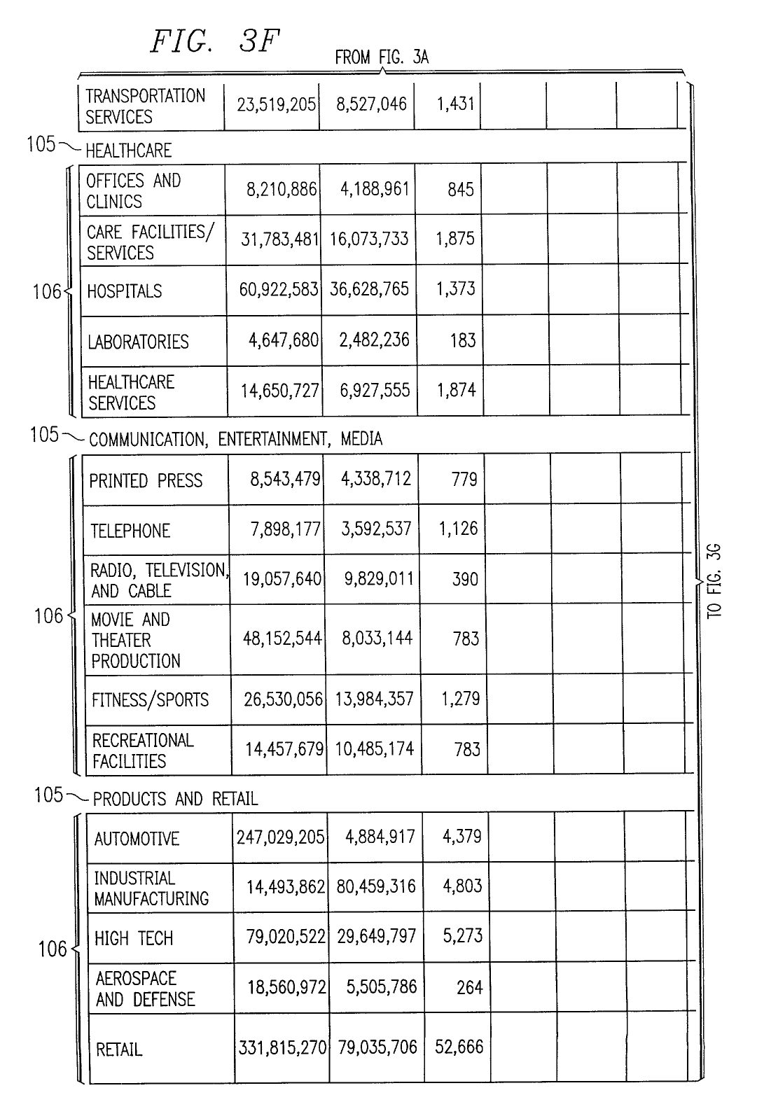

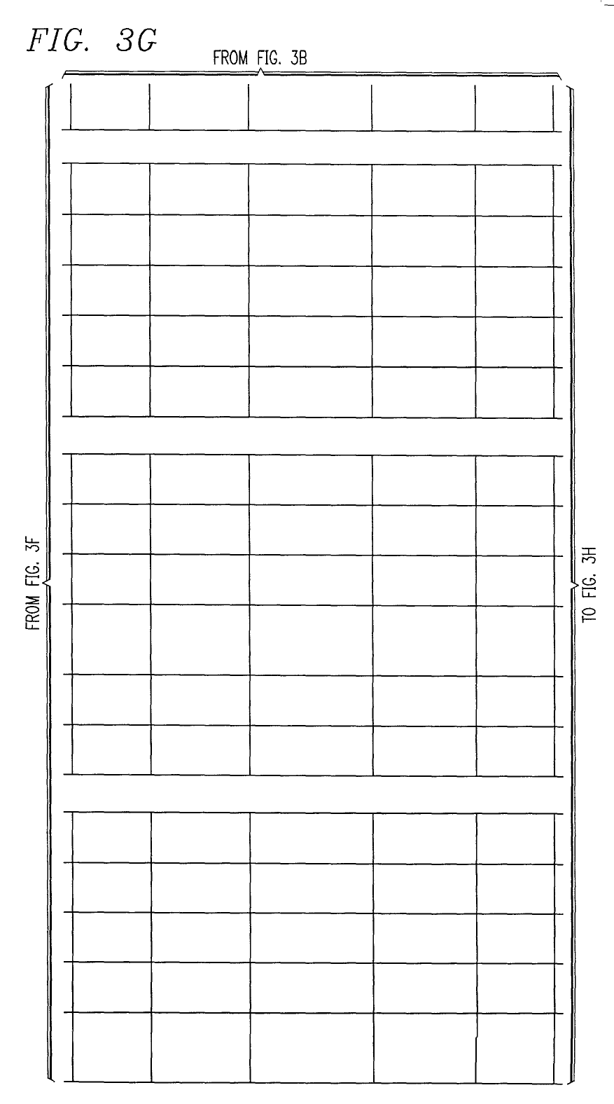

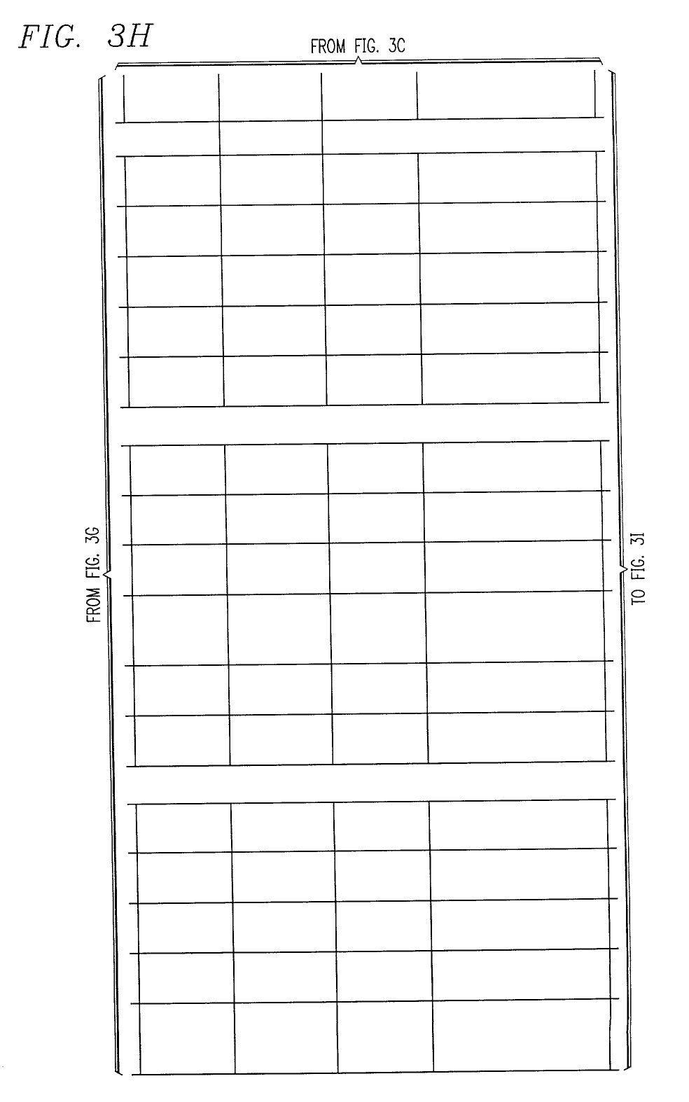

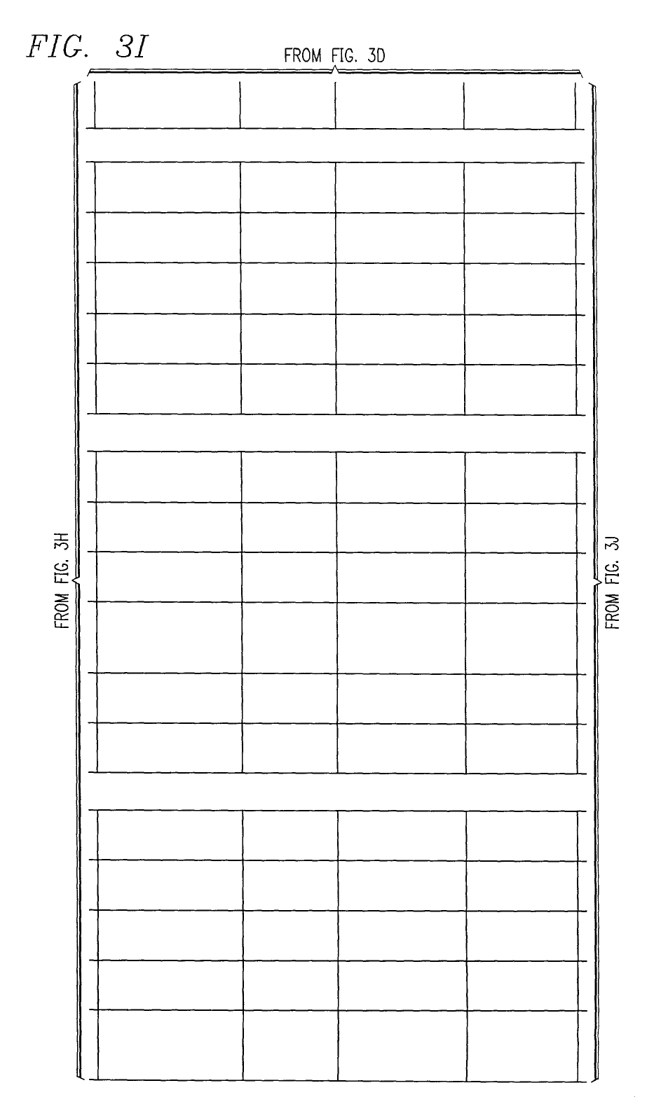

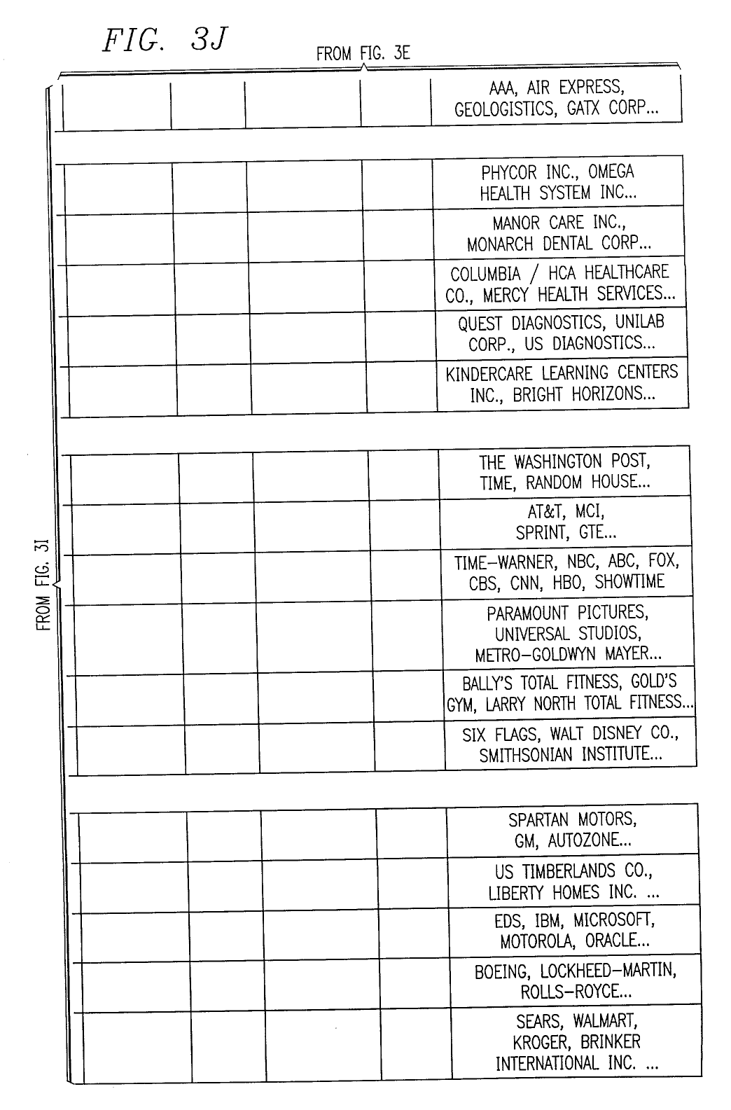

According to the teachings of the present invention, computer 200 is utilized by resource allocator 104 to facilitate service resources allocation. Computer 200 is described in detail below in conjunction with FIG. 2. However, generally, computer 200 is utilized to develop an industry customer value stream matrix 300 (FIGS. 3A through 3J) for use in determining service resources allocation. For computer 200 to perform this function, data and other information, such as public information 108, is accessed by computer 200.

Public information 108 includes any suitable public information regarding industry segments 106 and/or their associated companies. As examples, public information may include NAICS codes 110, NAICS financial information 112, SEC filings 114, or other miscellaneous information 116. NAICS codes 110 replaced the standard industrial classification system (“SICS”) codes in 1997, although the SICS codes are sometimes still referred to. NAICS is a system for classifying companies by type of economic activity to facilitate the collection, presentation, and analysis of data relating to companies, and to promote uniformity and comparability in the presentation of statistical data describing the economy. For example, if industry segment 106 was the electricity industry segment of the utilities industry, then NAICS codes could be 221111, which is hydroelectric power generation, 221112, which is fossil fuel electric power generation, or 48621, which is pipeline transportation of natural gas. NAICS financial information 112 is information available from the North American Industrial Classification System Association. SEC filings 114 is any information available from the SEC related to specific company financial filings. Miscellaneous information 116 is other suitable financial or other public domain information, such as information from the Department of Commerce or information obtained from industry magazines, newspapers, websites, or other suitable publications that may be useful in determining service resources allocation. Although the embodiment illustrated in FIG. 1 utilizes public information 108, non-public information may also be utilized in lieu of, or in addition to, public information 108 to develop industry customer value stream matrix 300.

FIG. 2 is a block diagram of computer 200 for use in determining services resources allocation according to one embodiment of the present invention. Computer 200 includes input device 202, output device 204, processor 206, memory 208 storing resources allocation application 210, and database 212.

Input device 202 is coupled to computer 200 for the purpose of inputting public information 108. In one embodiment, input device 202 is a keyboard; however, input device 202 may take other forms, such as a mouse, a stylus, or a scanner. Output device 204 may be any suitable visual display unit, such as a liquid crystal display (“LCD”) or cathode ray tube (“CRT”) display. Output device 204 may also be coupled to a printer (not shown) for the purpose of printing out any desired information, such as matrix 300 (FIGS. 3A through 3J).

Processor 206 comprises any suitable type of processing unit that executes logic. One of the functions of processor 206 is to retrieve resources allocation application 210 from memory 208 and execute resources allocation application 210 to develop matrix 300 as described more fully below. Processor 206 also controls the retrieving of information and data, such as public information 108, from database 212.

Resources allocation application 210 is a computer program written in any suitable computer language that is operable to utilize information contained in database 212 for the purpose of generating matrix 300 so that resource allocator 104 may determine service resources allocation for services company 102. Resources allocation application 210 is also operable to display matrix 300 on output device 204.

Memory 208 and database 212 may comprise files, stacks, databases, or other suitable organizations of volatile or non-volatile memory. Memory 208 and database 212 may be random access memory, read only memory, CD-ROM, removable memory devices, or any other suitable devices that allow storage and/or retrieval of data. Memory 208 and database 212 are interchangeable and may perform the same functions.

As described above, public information 108 is accessed by computer 200. Resource allocator 104 utilizes computer 200 to execute resources allocation application 210 for the purpose of manipulating public information 108 stored in database 212 into a usable form. One such usable form is matrix 300 as described in detail below in conjunction with FIGS. 3A through 3J FIGS. 3A through 3J illustrate one embodiment of matrix 300 used in determining service resources allocation. Matrix 300 may be either viewed on output device 204 or printed out in hard copy form. FIGS. 3A through 3J illustrate the entire matrix 300; however, desired portions of matrix 300 may be displayed on output device 204 or printed. Matrix 300 includes a generic value stream 302 having a plurality of generic value stream components 304, described below, that are associated with a plurality of industries 105 having associated industry segments 106. In the illustrated embodiment, matrix 300 includes public information 108 of industry segments 106 assimilated into columns of net sales 306, gross profit 308, number of firms 310, NAICS code list 312, input NAICS codes 314, and output NAICS codes 316. Other suitable breakdowns of public information 108 of industry segments 106 may be utilized. Matrix 300 also includes a plurality of expenditures 318, one or more operational variables 320 associated with generic value stream components 304, and a column of sample companies 322.

Generic value stream 302 includes generic value stream components 304, which are a set of generic steps or generic components that define the value of a company's products and/or services. Generic value stream components 304 are any suitable value stream components that are generic to all industry segments 106. In the illustrated embodiment, generic value stream components 304 include a market identified component, a product design/engineered component, a product manufactured component, a product stored/distributed component, a customer aware of need component, a customer finds product component, a customer makes final selection component, a customer orders product component, a product delivered component, a product installed component, a customer pays for product component, a customer uses product component, a customer needs product help component, a product is returned or exchanged component, a product repaired component, and a customer no longer needs product component. More, less, or different generic value stream components 304 may be utilized. Each of generic value stream components 304 are associated with industry segments 106.

Industry segments 106, as described above, are particular industry segments associated with industries 105. For example, as shown in matrix 300, the utilities industry includes water, electricity, oil and natural gas, chemicals, and the mining industry segments. Industry segments 106 are depicted in the FIGURE in rows in matrix 300. Adjacent industry segments 106 is public information 108. In the illustrated embodiment, public information 108 is depicted in six columns, which are net sales 306, gross profit 308, number of firms 310, NAICS code list 312, input NAICS codes 314, and output NAICS codes 316.

Net sales 306 are the total net sales of each industry segment 106 as extracted from public information 108. For example, as illustrated, the water industry segment may have a net sales of $5,446,264, which includes all the net sales of all the public companies affiliated with the water industry segment. Similarly, gross profit 308 is the total accumulation of gross profits of each industry segment 106 as extracted from public information 108. For example, in the water industry segment, gross profit 308 is $1,879,530, which is the total gross profit of all the companies related to the water industry segment.

Number of firms 310 is the total number of firms in which financial information is obtained. Number of firms 310 gives resource allocator 104 an indication of the size of each industry segment 106. NAICS code list 312 lists all the NAICS codes that are associated with each industry segment 106. NAICS code list 312 is used by resource allocator 104 for information purposes. Input NAICS codes 314 contains the NAICS codes of the respective industry segments 106 that serve each industry segment 106. For example, in the chemicals industry segment there may be an input NAICS code 212299 that designates that the mining industry segment is an input to the chemicals industry segment. Conversely, output NAICS codes 316 shows all the particular industry segments 106 that each industry segment 106 serves. For example, in the mining industry segment there is an output NAICS code of 331311 showing that the mining industry segment serves the chemicals industry segment.

The column of sample companies 322 illustrates sample companies that are in a particular industry segment 106. For example, in the water industry segment, as illustrated, matrix 300 shows American Water Works Company, Inc., and United Water Resources, Inc. There are other companies within this industry segment; however, only a few representative companies are shown in FIG. 3E.

Additional financial information is shown in matrix 300 in the form of expenditures 318. Expenditures 318 illustrate the total amount of expenditures for a particular industry segment 106. These expenditures 318 are associated with one or more generic value stream components 304. For example, in the electricity industry segment underneath the product design/engineered component 304 and the product manufactured generic value stream component 304 there is illustrated the word “generation.” The word “generation” is industry segment terminology for designing, engineering, and/or manufacturing their products. Shown under the “customer orders product” component and “product delivered” component is the word “transmission.” “Transmission” is industry segment terminology for the customer ordering the product and the product being delivered. The word “customer” under the “product installed” component is the electricity industry segment's terminology for expenditures related to installing the product.

Each of the generation, transmission, and customer components representing the generic value stream components 304 of the electricity industry segment has allocated expenditures in the form of, in one embodiment, certain dollar amounts. This is illustrated by arrow 324. In addition to, or in lieu of, each dollar amount 324 there may be a relative amount of expenditures, illustrated by arrow 326, that represent the relative amount of expenditures of that particular component compared to the total expenditures of that particular industry segment 106. In other words, a percentage of expenditures is shown, which illustrates that more expenditures 318 occur in one generic value stream component 304 or set of generic value stream components 304 than in a different generic value stream component 304 or set of generic value stream components 304. As described more fully below, the amount of expenditures 318 or relative amount of expenditures may alert resource allocator 104 that professional resources need to be allocated to this particular generic value stream component 304 or set of generic value stream components 304.

Expenditures 318 illustrate expenditures for particular generic value stream components 304 for a predetermined time period. In one particular embodiment, a time period is equal to one year, which is typically the time period over which public information 108 is available. However, other time periods may be represented in matrix 300. In another embodiment, expenditures 318 are replaced by a change in expenditures. Accordingly, expenditures 318 would illustrate a change in expenditures for a particular generic value stream component 304 or set of generic value stream components 304 between time periods. As an example, in the electricity industry segment expenditures for the generation component may drop by $100 million from one year to the next. This $100 million is shown in the box associated with the electricity industry segment and the corresponding generic value stream component or components 304.

Each industry segment 106 may have different terms to represent one or more generic value stream components 304. In addition, some industry segments 106 may have one or more generic value stream component columns blank because certain generic value stream components 304 are not applicable to every industry segment 106.

As described above, matrix 300 also has operational variables 320. Operational variables 320 are variables that describe how services company 102 adds value to a particular industry segment 106. As examples, operational variables 320 may be such things as “makes process less complex,” “makes ordering a product more convenient,” “makes installing a product easier,” and “makes customer understand the value of a product.” Operational variables 320 shown on matrix 300 may alert resource allocator 104 to other potential new additional operational variables 320 to further enhance the value of their services.

In accordance with the present invention, matrix 300 may be utilized by resource allocator 104 to determine service resources allocation in many different ways. For example, resource allocator 104 may determine the relative amount of expenditures associated with at least one generic value stream component 304 based on allocated expenditures 318 and identify that a high percentage of expenditures 318 are allocated to one or more generic value stream components 304. This identification may alert resource allocator 104 that service resources should be allocated to those respective generic value stream components 304 for that respective industry segment 106. In another example, resource allocator 104 may determine at least one expenditure trend associated with at least one generic value stream component 304 based on allocated expenditures 308, and identify a significant change in expenditures 318 between time periods for respective generic value stream components 304 for a particular industry segment 106. This identification may alert resource allocator 104 that service resources should be allocated to those respective generic value stream components 304 for that respective industry segment 106. As an additional example, resource allocator 104 may just determine service resources allocation based on allocated revenue information or based on the allocated change in revenues between at least two time periods for a particular industry segment 106. A still further example of how matrix 300 may be utilized by resource allocator 104 to determine service resources allocation is as follows: Resource allocator 104 may determine service resources allocation for a second industry segment 106 based on a revenue information trend associated with a first industry segment 106, which is based on an allocated change in revenue information for the first industry segment.

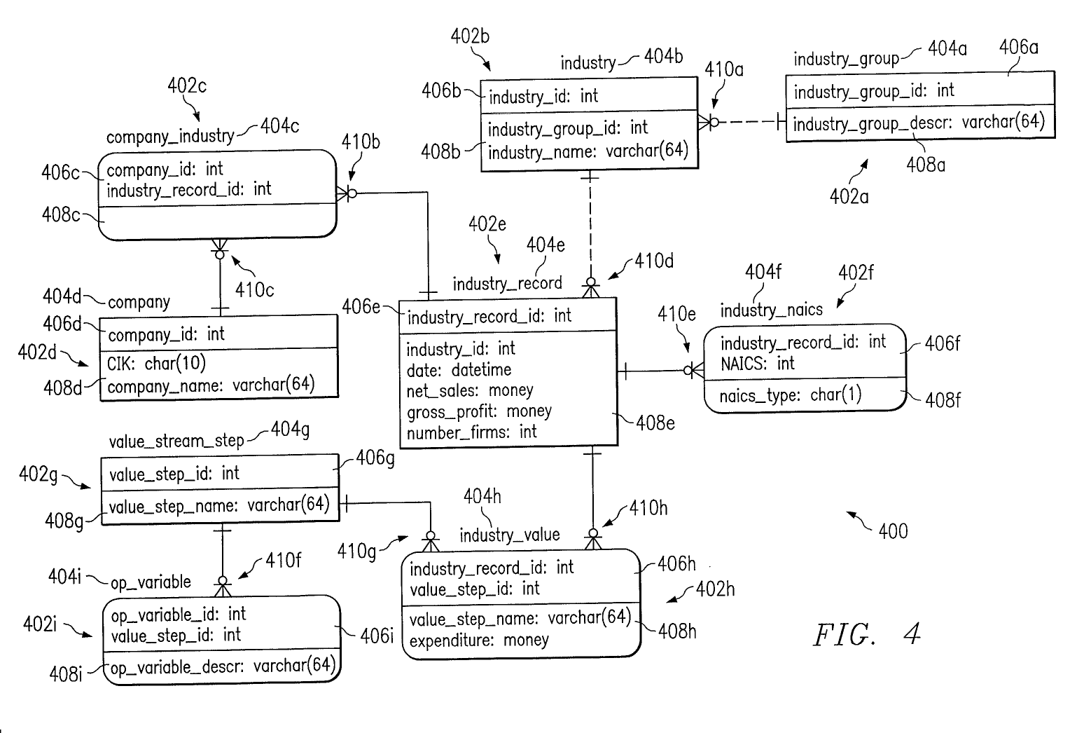

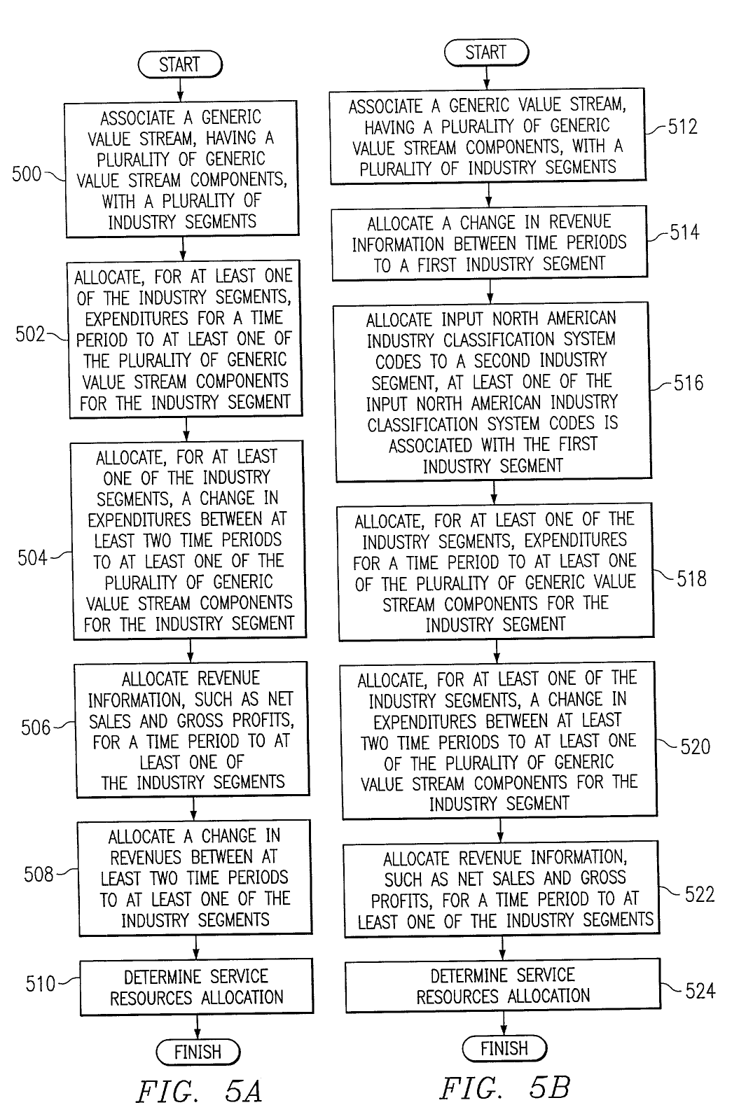

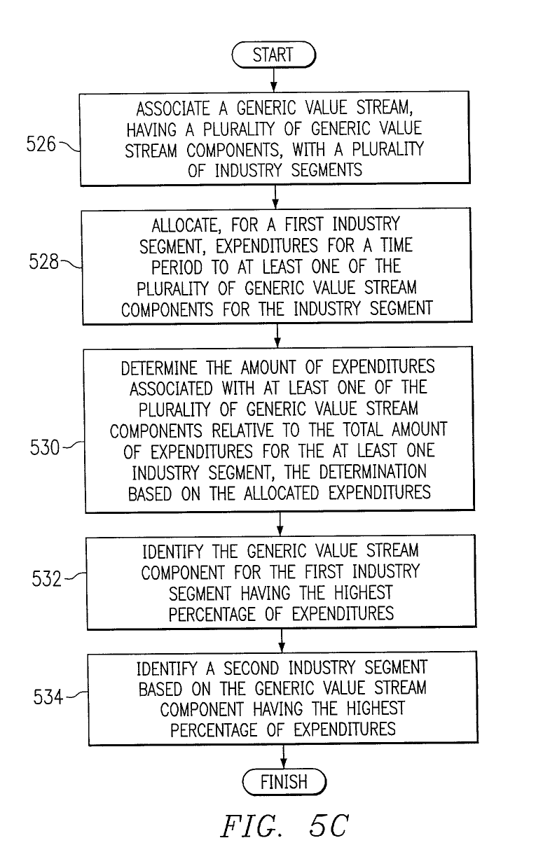

Additional details of how matrix 300 is used by resource allocator 104 is described below in conjunction with FIGS. 5A through 5C. However, before describing example uses of matrix 300, one embodiment of a data model 400 for use in computer 200 is described in conjunction with FIG. 4 below.

FIG. 4 is diagram illustrating one embodiment of a data model 400 for use in computer 200. As described above, public information 108 may be provided to computer 200 by, for example, resource allocator 104 or other suitable personnel of services company 102. Public information 108, in one embodiment, is stored as database 212. One way of generating database 212 is illustrated by data model 400 of FIG. 4.

Data model 400 includes a plurality of tables 402a through 402i, each having a table name 404a through 404i, a key 406a through 406i, and one or more attributes 408a through 408i. Keys 406a through 406i are identifiers for a record or group of records in tables 402a through 402i. Attributes 408a through 408i describe the domain, type, and size of a record. Data model 400 also includes a plurality of relational symbols 410a through 410h that describes the relationship between tables 402a through 402i.

As one example of how data model 400 is arranged, table 402a has a table named 404a called “industry_group.” Table 402a designates the different industries depicted in matrix 300. Each industry name is identified by key 406a. Attributes 408a of table 402a is each entry consists of variable characters with no more than 64 characters allowed. For example, as shown in matrix 300 in FIGS. 3A through 3J, the first industry group is the utilities industry. Table 402a is related to table 402b as illustrated by relational symbol 410a. This means that each industry group entry has many industry segments 106. Industry segments 106 are identified by key 406b and each industry segment 106 has a name that is no more than 64 variable characters as denoted by attribute 408b. Other tables 402b through 402i in data model 400 are similarly related and one skilled in the art understands the contents of FIG. 4.

FIGS. 5A through 5C are three different flowcharts illustrating various embodiments of methods for determining service resources allocation.

FIG. 5A is a flowchart illustrating one example of how resource allocator 104 may determine service resources allocation by utilizing matrix 300. At step 500, generic value stream 302 having generic value stream components 304 are associated with industry segments 106. At step 502, expenditures 318 for a time period for at least one of industry segments 106 are allocated to at least one of generic value stream components 304 for industry segment 106. At step 504, a change in expenditures between at least two time periods for at least one of industry segments 106 is allocated to at least one generic value stream component 304 for industry segment 106. At step 506, revenue information, such as net sales 306 and gross profit 308, for a time period is allocated to at least one of industry segments 106. At step 508, the change in revenues between at least two time periods is allocated to at least one of industry segments 106. At step 510, service resources allocation is determined by resource allocator 104.

FIG. 5B is a flowchart illustrating another example of how resource allocator 104 may determine service resources allocation by utilizing matrix 300. At step 512, generic value stream 302 having generic value stream components 304 are associated with industry segments 106. At step 514, a change in revenue information between time periods is allocated to a first industry segment. At step 516, input NAICS codes 314 are allocated to a second industry segment 106. At least one of the NAICS codes 314 are associated with the first industry segment 106. At step 518, expenditures 318 for a time period for at least one of the industry segments 106 are allocated to at least one of generic value stream components 304. At step 520, a change in expenditures between at least two time periods for at least one of industry segments 106 is allocated to at least one of generic value stream components 304. At step 522, revenue information, such as net sales 306 and gross profits 308, for a time period are allocated to at least one of industry segments 106. At step 524, service resources allocation is determined by resource allocator 104.

FIG. 5C is a flowchart illustrating yet another example of how resource allocator 104 may determine service resources allocation by utilizing matrix 300. At step 528, expenditures 318 for a time period for a first industry segment are allocated to at least one of generic value stream components 304 for the first industry segment. At step 530, the amount of expenditures 318 associated with the at least one generic value stream components relative to the total amount of expenditures for the at least one industry segments 106 is determined based on expenditures 318 allocated in step 528 above. At step 532, resource allocator 104 identifies the generic value stream component 304 for the first industry segment having the highest percentage of expenditures 318. At step 534, resource allocator 104 identifies a second industry segment based on the generic value stream component 304 having the highest percentage of expenditures. Identifying this second industry segment allows resource allocator 104 to determine that service resources may need to be allocated to this second industry segment.

Although embodiments of the invention and their advantages are described in detail, a person skilled in the art could make various alterations, additions, and omissions without departing from the spirit and scope of the present invention as defined by the appended claims.

What is claimed is:

1. A method for determining resource allocation, comprising:
associating a generic value stream having a plurality of generic value stream components with a plurality of industry segments;
allocating, for at least one of the industry segments, expenditures for a time period to at least one of the plurality of generic value stream components for the industry segment; and
determining, for at least one of the industry segments, the amount of expenditures associated with the at least one of the plurality of generic value stream components relative to the total amount of expenditures for the at least one industry segment, the determination for use in determining the resource allocation.

2. The method of claim 1, further comprising:
allocating, for at least one of the industry segments, a change in expenditures between at least two time periods to at least one of the plurality of generic value stream components for the industry segment;
determining, for at least one of the industry segments, at least one expenditure trend associated with the at least one of the plurality of generic value stream components based on the allocated change in expenditures for use in determining the resource allocation.

3. The method of claim 1, further comprising:
allocating revenue information for a time period to at least one of the industry segments, the revenue information selected from the group consisting of net sales and gross profits;
determining the resource allocation based on the allocated revenue information.

4. The method of claim 1, further comprising:
allocating a change in revenues between at least two time periods to at least one of the industry segments;
determining at least one revenue trend associated with the at least one industry segment based on the allocated change in revenues for use in determining the resource allocation.

5. The method of claim 1, further comprising
allocating a plurality of operational variables with the generic value stream components; and
determining at least one new operational variable associated with at least one of the generic value stream components based on the allocated expenditures.

6. The method of claim 1, wherein the plurality of generic value stream components comprises:
a market identified component;
a product engineered component;
a product manufactured component;
a product stored or distributed component;
a customer aware of need component;
a customer finds product component;
a customer makes final selection component;
a customer orders product component;
a product delivered component;
a product installed component;
a customer pays for product component;
a customer uses product component;
a customer needs product help component;
a product is returned or exchanged component;
a product is repaired component; and
a customer no longer needs component.

7. The method of claim 1, wherein the plurality of industry segments are associated with a plurality of industries comprising:
a utilities industry;
a financial and transportation industry;
a healthcare industry;
a communication, entertainment, and media industry; and
a products and retail industry.

8. The method of claim 1, wherein the time period is one year.

9. A system for facilitating resource allocation, comprising:
a computer-readable medium;
a database storing expenditures for a time period for a plurality of industry segments, the expenditures associated with at least one of a plurality of generic value stream components; and
a computer program stored on the computer-readable medium operable to display a desired portion of the database.

10. The system of claim 9, wherein the desired portion is the entire database.

11. The system of claim 9, wherein the database further stores a change in expenditures between at least two time periods for at least one of the plurality of industry segments, the change in expenditures associated with at least one of the plurality of generic value stream components.

12. The system of claim 9, wherein the database further stores revenue information for a time period for at least one of the plurality of industry segments, the revenue information selected from the group consisting of net sales and gross profits.

13. The system of claim 9, wherein the database further stores a change in revenue information between at least two time periods for at least one of the plurality of industry segments, the change in revenue information selected from the group consisting of a change in net sales and a change in gross profits.

14. The system of claim 9, wherein the database further stores a plurality of operational variables associated with the generic value stream components.

15. The system of claim 9, wherein the plurality of generic value stream components comprises:
a market identified component;
a product engineered component;
a product manufactured component;
a product stored or distributed component;
a customer aware of need component;
a customer finds product component;
a customer makes final selection component;
a customer orders product component;
a product delivered component;
a product installed component;
a customer pays for product component;
a customer uses product component;
a customer needs product help component;
a product is returned or exchanged component;
a product is repaired component; and
a customer no longer needs component.

16. The system of claim 9, wherein the plurality of industry segments are associated with a plurality of industries comprising:
a utilities industry;
a financial and transportation industry;
a healthcare industry;
a communication, entertainment, and media industry; and
a products and retail industry.

17. The system of claim 9, wherein the time period is one year.

18. A method for determining resource allocation, comprising:
associating a generic value stream having a plurality of generic value stream components with a plurality of industry segments;
allocating a change in revenue information between time periods to a first industry segment, the revenue information selected from the group consisting of net sales and gross profits;
allocating input North American Industry Classification System codes to a second industry segment, wherein at least one of the input North American Industry Classification System codes is associated with the first industry segment; and
determining a revenue information trend associated with the first industry segment based on the allocated change in revenue information for use in determining the resource allocation for the second industry segment.

19. The method of claim 18, further comprising:
allocating, for at least one of the industry segments, expenditures for a time period to at least one of the plurality of generic value stream components for the industry segment; and
determining the amount of expenditures associated with the at least one of the plurality of generic value stream components relative to the total amount of expenditures for the industry segment, the determination for use in determining the resource allocation.

20. The method of claim 18, further comprising:
allocating, for at least one of the industry segments, a change in expenditures between at least two time periods to at least one of the plurality of generic value stream components for the industry segment;
determining at least one expenditure trend associated with the at least one of the plurality of generic value stream components based on the allocated change in expenditures for use in determining the resource allocation.

21. The method of claim 18, further comprising:
allocating revenue information for a time period to at least one of the industry segments, the revenue information selected from the group consisting of net sales and gross profits;
determining the resource allocation based on the allocated revenue information.

22. The method of claim 18, further comprising
allocating a plurality of operational variables with the generic value stream components; and
determining at least one new operational variable associated with at least one of the generic value stream components based on the allocated expenditures.

23. The method of claim 18, wherein the time periods are each one year.

24. A system for facilitating service resources allocation, comprising:
a computer-readable medium;
a database storing a change in revenue information between time periods for a first industry segment, the revenue information selected from the group consisting of net sales and gross profits, and storing at least one input North American Industry Classification System code for a second industry segment, the input North American Industry Classification System code associated with the first industry segment; and
a computer program stored on the computer-readable medium operable to display a desired portion of the database.

25. The system of claim 24, wherein the desired portion is the entire database.

26. The system of claim 24, wherein the database further stores expenditures for a time period for at least one of the industry segments, the expenditures associated with at least one of the plurality of generic value stream components.

27. The system of claim 24, wherein the database farther stores a change in expenditures between at least two time periods for at least one of the industry segments, the change in expenditures associated with at least one of the plurality of generic value stream components.

28. The system of claim 24, wherein the database further stores revenue information for a time period for at least one of the industry segments, the revenue information selected from the group consisting of net sales and gross profits.

29. The system of claim 24, wherein the database further stores a plurality of operational variables associated with the generic value stream components.

30. The system of claim 24, wherein the time periods are each one year.

31. A method for determining resource allocation, the method comprising:
associating a generic value stream having a plurality of generic value stream components with a plurality of industry segments;
allocating, for a first industry segment, expenditures for a time period to at least one of the plurality of generic value stream components for the first industry segment;
determining the amount of expenditures associated with the at least one of the plurality of generic value stream components relative to the total amount of expenditures for the at least one industry segment, the determination based on the allocated expenditures;
identifying the generic value stream component for the first industry segment having the highest percentage of expenditures; and
identifying a second industry segment based on the generic value stream component having the highest percentage of expenditures.

32. The method of claim 31, further comprising:
allocating, for at least one of the industry segments, a change in expenditures between at least two time periods to at least one of the plurality of generic value stream components for the industry segment;
determining at least one expenditure trend associated with the at least one of the plurality of generic value stream components based on the allocated change in expenditures for use in determining the resource allocation.

33. The method of claim 31, further comprising:
allocating revenue information for a time period to at least one of the industry segments, the revenue information selected from the group consisting of net sales and gross profits;
determining the resource allocation based on the allocated revenue information.

34. The method of claim 31, further comprising:
allocating a change in revenues between at least two time periods to at least one of the industry segments;
determining at least one revenue trend associated with the at least one industry segment based on the allocated change in revenues for use in determining the resource allocation.

35. The method of claim 31, further comprising:
allocating a plurality of operational variables with the generic value stream components; and
determining at least one new operational variable associated with at least one of the generic value stream components based on the allocated expenditures.

36. The method of claim 31, wherein the time period is one year.

37. A system for facilitating resource allocation, comprising:
a computer-readable medium;
a database storing expenditures for a time period for a first industry segment, the expenditures associated with at least one of a plurality of generic value stream components; and
a computer program stored on the computer-readable medium operable to determine the amount of expenditures associated with the at least one of the plurality of generic value stream components relative to the total amount of expenditures for the at least one industry segment, the computer program further operable to identify the generic value stream component for the first industry segment having the highest percentage of expenditures, identify a second industry segment based on the generic value stream component having the highest percentage of expenditures, and display a desired portion of the database.

38. The system of claim 37, wherein the desired portion is the entire database.

39. The method of claim 37, wherein the database further stores a change in expenditures between at least two time periods for at least one of the industry segments, the change in expenditures associated with at least one of the plurality of generic value stream components for the industry segment.

40. The method of claim 37, wherein the database further stores revenue information for a time period for at least one of the industry segments, the revenue information selected from the group consisting of net sales and gross profits.

41. The method of claim 37, wherein the database further stores a change in revenues between at least two time periods for at least one of the industry segments.

42. The method of claim 37, wherein the database further stores a plurality of operational variables associated with the generic value stream components.

43. The method of claim 37, wherein the time period is one year.
